(19) United States
(12) Patent Application Publication
(10) Pub. No.: US 2005/0214178 A1
(43) Pub. Date: Sep. 29, 2005

(54) Catalytic converter system and method of making the same

(76) Inventors: William J. LaBarge, Bay City, MI (US); Russell P. Richmond, Clifford, MI (US); Michael R. Foster, Columbiaville, MI (US)

Correspondence Address: Paul L. Marshall;Delphi Technologies, Inc., M/C 480-410-202, P.O. Box 5052, Troy, MI, 48007, US

(21) Appl. No.: 10/811,131

(22) Filed: Mar. 26, 2004

(51) Int. Cl. B01D 53/34

(52) U.S. Cl. 422/180; 422/177; 29/890

(57) ABSTRACT

A catalytic converter system comprises an upstream catalytic converter comprising an upstream substrate having an upstream catalyst disposed thereon, wherein greater than or equal to 70 wt % of the upstream catalyst is disposed at a core of the upstream substrate, wherein the weight percent is based on a total weight of the upstream catalyst disposed on the upstream substrate.

### BACKGROUND

Catalytic converters containing various catalysts have been employed for years by automobile manufacturers to meet the ever-more stringent regulations on emissions of hydrocarbons, carbon monoxide, and nitrogen oxides from internal combustion engines. The continuing evolution and tightening of these regulations has made necessary the development of systems that control emission of hydrocarbons during the period immediately after start of a cold engine and before the catalytic converter normally supplied by automobile manufacturers has been sufficiently warmed by engine exhaust gas to be effective in converting hydrocarbons (often referred to as “cold start conditions”).

A catalytic converter may be placed anywhere in the exhaust system. However, it may be advantageous to locate a catalytic converter as close as possible to the combustion chamber in an engine compartment. Placing a catalytic converter closer to the combustion chamber quickens the converter's light-off time. The light-off time is the point at which the catalyst reaches fifty percent efficiency, i.e., when greater than fifty percent of the hydrocarbons in the exhaust fluid are converted, over a period of time (measured in seconds) during start-up of the automobile.

Generally, the closer a catalytic converter is to the combustion chamber the better, i.e., quicker, the light-off time, but the higher the operating temperature is in the converter. However, as the converter operating temperature increases, the percent conversion of nitrogen oxides (NOₓ) and carbon monoxide (CO) may decrease.

Accordingly, what is needed in the art is a catalytic converter or catalytic converter system with a faster light-off time compared to existing catalytic converters, while being able to reduce nitrogen oxides to acceptable governmental regulation levels.

### SUMMARY

An embodiment of a catalytic converter system comprises an upstream catalytic converter comprising an upstream substrate having an upstream catalyst disposed thereon, wherein greater than or equal to 70 wt % of the upstream catalyst is disposed at a core of the upstream substrate, wherein the weight percent is based on a total weight of the upstream catalyst disposed on the upstream substrate.

Another embodiment of a catalytic converter system comprises an upstream catalytic converter configured to maintain laminar fluid flow therethrough; and a downstream catalytic converter in fluid communication with the upstream catalytic converter, wherein the downstream catalytic converter is configured to maintain turbulent flow at least through a portion thereof.

An embodiment of a method of making a catalytic converter, the method comprises drying an upstream substrate comprising a catalyst material, wherein greater than or equal to 60 wt % based on a total weight of catalyst disposed in the upstream substrate is disposed at a core of the upstream substrate; drying a downstream substrate comprising a catalyst material, wherein greater than or equal to 60 wt % based on a total weight of the catalyst material disposed in the downstream substrate is distributed at a bulk of the substrate downstream substrate; wrapping a retention material around the upstream substrate and the downstream substrate; and disposing the retention material, the upstream substrate, and the downstream substrate in a housing, wherein a gap of up to about 20 mm is created between the upstream substrate and the downstream substrate.

The above-described and other features will be appreciated and understood by those skilled in the art from the following detailed description, drawings, and appended claims.

### BRIEF DESCRIPTION OF THE DRAWINGS

Referring now to the figures, which are exemplary embodiments, and wherein the like elements are numbered alike:

FIG. 1 is a cross sectional view of a catalytic converter system comprising an upstream catalytic converter and a downstream catalytic converter.

FIG. 2 is a cross sectional view of a catalytic converter system comprising an upstream substrate and a downstream substrate packaged together in a housing.

FIG. 3 is a graph of hydrocarbon emissions as a function of time for various converter design variables.

FIG. 4a is a cross sectional view of a rounded substrate.

FIG. 4b is a cross sectional view of a rounded substrate.

FIG. 4c is a cross sectional view of a rounded substrate

FIG. 5 is a cross sectional view of a converter illustrating a substrate core.

### DETAILED DESCRIPTION

While a catalytic system disclosed herein is particularly useful for a gasoline engine system, it may also be adapted for other engines, including a diesel engine system. In describing the arrangement of exhaust treatment devices (e.g., catalytic converters) within the system, the terms “upstream” and “downstream” are used. These terms, as used herein, have their ordinary meaning. For example, “upstream” and “downstream” refers to elements relative locations in a flow stream, based upon the flow direction, wherein a downstream element would be disposed to receive the flow stream subsequent to an upstream element.

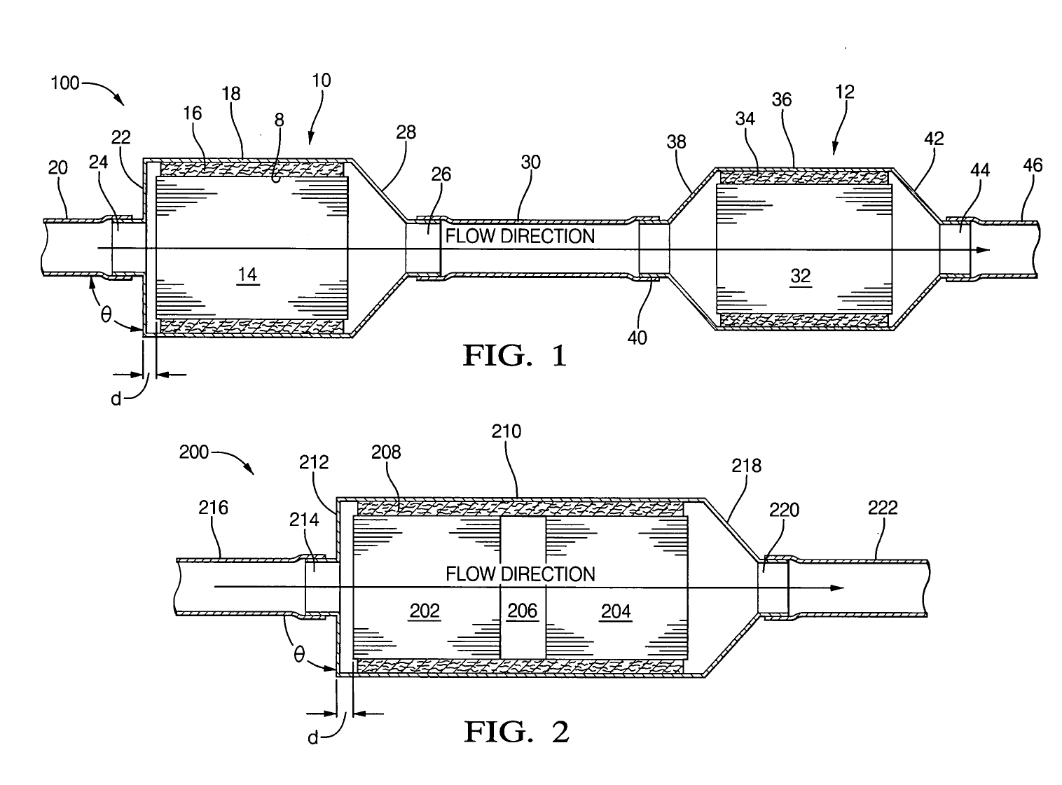

Referring now to FIG. 1, a catalytic converter system generally designated 100 is illustrated. System 100 comprises an upstream catalytic converter 10 and a downstream catalytic converter 12. Preferably, the upstream converter 10 is a close-coupled converter, while the downstream converter 12 is preferably an under-floor catalytic converter. The terms “close-coupled” and “under-floor” are used to describe the location of a catalytic converter in system 100. Those skilled in the art generally use at least the following three terms to describe the location of a catalytic converter: manifold mounted, close-coupled, and under-floor. Manifold mounted is directly connected to the manifold outlet of an engine; closed-coupled is located in the engine compartment of a vehicle (e.g., less than or equal to 200 millimeters (mm) from the manifold outlet); and under-floor is located the farthest away from the engine located under the floor region of a vehicle (e.g., greater than or equal to 1,200 mm from the manifold outlet).

Upstream converter 10 comprises a housing 18 with a retention material 16 disposed between the housing 18 and a catalytic substrate 14, wherein the retention material 16 may be a material wrapped around the catalytic substrate 14 forming a subassembly. An arrow labeled “flow direction” schematically illustrates the general flow direction of exhaust in system 100. Exhaust fluid is allowed to enter the upstream converter 10 through an inlet 24 in endplate 22. Exhaust fluid enters opening 24, passes through substrate 14, and exits an opening 26 of an endcone 28. However, in other embodiments, endcone 28 may be an end plate (not shown). Opening 26 is sized to receive exhaust conduit 30, which is in fluid communication with downstream catalytic converter 12.

Downstream converter 12 is in fluid communication with upstream converter 10 via exhaust conduit 30. Downstream converter 12 comprises a catalytic substrate 32 optionally wrapped in a retention material 34 forming a subassembly, which is encased in a housing 36. An end-cone 38 has an opening 40 sized to receive exhaust conduit 30. Exhaust fluid enters end-cone 38 through opening 40, passes through substrate 32, an exists through a second end-cone 42 having an opening 44 sized to receive outlet exhaust conduit 46.

Upstream converter 10 is particularly useful as a light-off catalyst for the conversion of hydrocarbons during start-up conditions. Additionally, upstream converter 10 offers improved light-off times during start-up conditions. Generally, light-off times for a close-coupled converter are about 35 seconds to about 45 seconds. When upstream converter 10 is a close-coupled converter, a light-off time of less than or equal to 25 seconds can be typical, with less than or equal to 15 seconds readily attained. With stricter environmental controls being placed on emissions, a reduced time for light-off is advantageous for compliance with environmental regulations.

As will be discussed in greater detail, several design features/variables have been discovered to impart this advantageously fast light-off time. For example, design variables include, but are not limited to, the location of the converter (e.g., close-coupled), the shape of the catalyst substrate (e.g., rounded), the catalyst distribution in the catalyst substrate (e.g., substantially distributed near the core of the catalyst substrate), the use of an end plate instead of an endcone at the inlet to the converter, the size of the exhaust conduit and the substrate, and/or the angle at which the exhaust conduit is attached to the end plate.

Generally, the closer a catalytic converter is located to the engine, the greater the operating temperature, because the exhaust fluid temperature is higher at locations more close to the engine. As such, a manifold mounted converter generally is operated at a higher temperature than a close-coupled converter, which in turn operates at a higher temperature than an under-floor converter. The catalytic reactions that take place in a catalytic converter are exothermic. As such, catalytic converter temperatures may have a temperature up to about 100° C. higher than the exhaust fluid entering the catalytic converter. As such, the closer a converter is located to an engine, the faster the light-off time is due to the higher temperatures. At these higher operating temperatures, however, the catalytic converter is not as efficient in reducing nitrogen oxides and carbon monoxide.

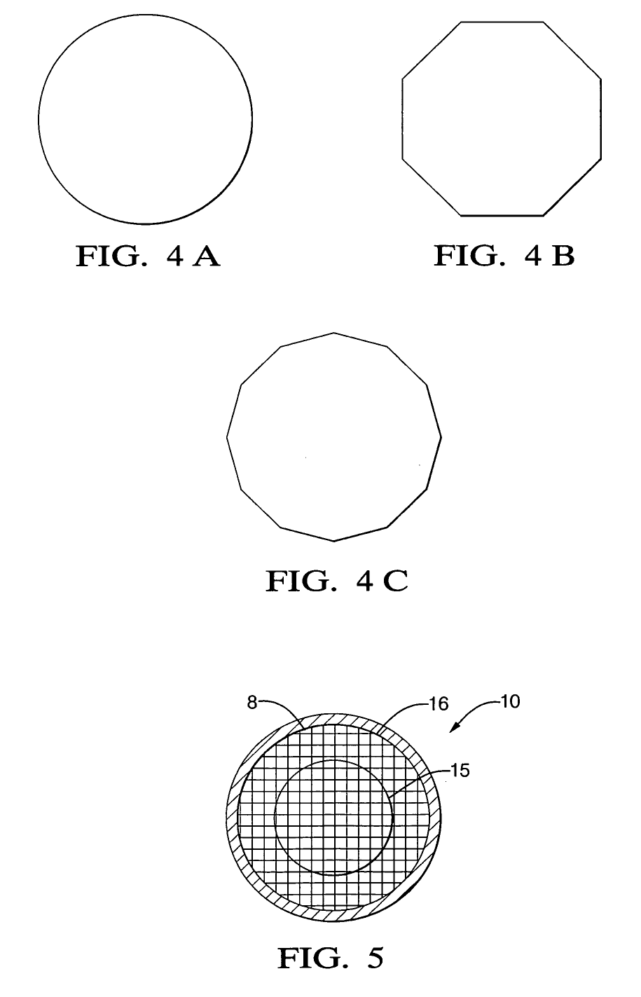

In an exemplary embodiment, the upstream converter 10 is a close-coupled catalytic converter. Although upstream converter 10 may have any shape or size, it preferably has a size and shape substantially the same as substrate 14. Although substrate 14 may have any shape (e.g., oval, round, polygonal, or the like), substrate 14 preferably has a rounded geometry. The term “rounded” has its ordinary meaning in the art. In other words, a rounded substrate is substantially cylindrical. However, manufacturing tolerances of the rounded substrate may allow a generally irregular shaped substrate to be produced, which may include a multi-sided cross sectional geometry taken perpendicular to the major axis (e.g. octagonal). The term “rounded” therefore includes those irregular geometries (e.g., FIG. 4b-4c). Preferably, the rounded substrate is completely cylindrical (FIG. 4a). Further, it is therefore noted that a rounded substrate (e.g., substantially cylindrical) is a different geometry than an oval substrate.

It is noted that all else being equal, a rounded catalyst substrate provides for faster light-off compared to other shaped catalyst substrates, e.g., oval. Without being bound to theory, the rounded catalyst substrate allows for laminar flow at least through a portion of the catalyst substrate, whereas an oval substrate creates turbulent flow regardless of the shape of an end-cone or end plate, and the thermal transfer through the substrate is not substantially uniform in an oval substrate.

In various embodiments, a catalyst is distributed at a bulk of substrate. In describing the catalyst, the catalyst may be disposed on/in the substrate. However, for the purposes of convenience, the term “on” the substrate shall be used hereinafter. The term “bulk” is used herein to refer to the entire body of the substrate, as opposed to a “core” of the substrate, which is defined below. In the upstream converter 10, the catalyst is preferably disposed to create a concentration gradient, i.e., a higher concentration of catalyst at the core than near the sides 8 of the substrate 14. Preferably, the catalyst is substantially disposed at the core where the flow volume is the greatest due to the flow profile created by the end plate 22. The term “core” is being used herein to generally designate an inner most portion that is substantially cylindrical having the same major and minor axis as the substrate, wherein the core has a diameter less than or equal to 63% of the overall diameter of the substrate. An exemplary core 15 can be seen in FIG. 5, which is a cross-sectional view of a converter (e.g., upstream converter 10). In this example, the region of the substrate representing the core has been shaded. Additionally, as will be discussed in greater detail below, the core may be further subdivided to create yet even smaller cores, e.g., a core having a diameter less than or equal to 40% of the diameter of the substrate.

Within the core 15 of the substrate 14, greater than or equal to 60 wt % of the total weight of catalyst employed on the substrate 14 is disposed, with greater than or equal to 80 wt % preferred. Focusing the flow stream through the substrate (e.g., via the use of an end plate or other device capable of focusing the flow stream) and disposing the catalyst in the area of greatest flow volume, allows more hydrocarbons to react on the catalyst compared to having catalyst dispersed generally equally over the entire substrate. As such, a faster light-off time may be obtained, compared to substrates having catalyst dispersed over the entire substrate. In other words, locating the catalyst at the core of the substrate is a more efficient use of the catalyst.

It is noted that the intent is to focus the flow stream and to dispose a majority of the catalyst within that flow stream. Therefore, an alternative embodiment comprises focusing the flow stream such that greater than or equal to 30 volume percent (vol %) of the flow passing through the substrate (based upon the total flow passing through the substrate) passes through a flow area comprising less than or equal to 40% of a cross-sectional of the substrate taken along a minor axis (i.e., along a direction that is perpendicular to the direction of flow of the flow stream). Preferably the flow volume passing through a flow area comprising less than or equal to 45% of a cross-sectional area of the substrate, is greater than or equal to 40 vol %, with greater than or equal to 50 vol % more preferred, greater than or equal to 60 vol % even more preferred, and greater than or equal to 70 vol % yet more preferred. It is also noted that the flow area comprises greater than or equal to 60 wt % of the total weight of catalyst employed on the substrate 14, with greater than or equal to 80 wt % preferred.

For example, the upstream converter 10 may be about 2 inches (about 5.08 cm) in diameter to about 8.0 inches (about 20.32 cm) in diameter. Preferably, the diameter is greater than or equal to 4 inches (about 10.16 cm), with greater than or equal to 5 inches (about 12.17 cm) preferred. The upstream converter 10, may be about 2.0 inches (about 5.08 cm) in length to about 8.0 inches (20.32 cm) in length, and may comprise one or more bricks. Preferably, the upstream converter comprises a length of greater than or equal to 3.0 inches (7.62 cm), with about 4.5 inches (about 11.42 cm) to about 6.0 inches (about 15.24 cm) preferred.

If a two brick system is employed, each of the bricks preferably comprises a length of about 2.0 inches (about 5.08 cm) to about 3.0 inches (7.62 cm). A gap between the bricks may be up to about 30 millimeter (mm). Preferably, the gap between the bricks is less than or equal to 20 mm, with less than or equal to 10 mm preferred, and less than or equal to 5 mm more preferred.

In one embodiment, the upstream converter 10 is configured to receive greater than or equal to 30% of the exhaust flow volume through a core having a diameter of about 30% of the overall diameter of the substrate. In another embodiment, the upstream converter 10 is configured to receive greater than or equal to 40% of the exhaust flow volume through a core having a diameter of about 44% of the overall diameter of the substrate. Preferably, the upstream converter 10 is configured to receive greater than or equal to 45% of the exhaust volume through the core having the diameter of about 44% of the overall diameter of the substrate, with greater than or equal to 50% of the exhaust volume passing through the core preferred. In yet another embodiment, the upstream converter 10 is configured to receive greater than or equal to 50% of the exhaust flow volume through a core having a diameter of about 54% of the overall diameter of the substrate. More preferably, the upstream converter 10 is configured to receive greater than or equal to 60% of the exhaust flow volume through the core having the diameter of about 54% of the overall diameter of the substrate, with greater than or equal to 70% of the exhaust flow volume preferred. In a further embodiment, the upstream converter 10 is configured to receive greater than or equal to 60% of the exhaust flow volume through a core having a diameter of about 63% of the overall diameter of the substrate. Preferably, the upstream converter 10 is configured to receive greater than or equal to 70% of the exhaust flow volume through the core having the diameter of about 63% of the overall diameter of the substrate, with greater than or equal to 90% of the exhaust flow more preferred.

Similarly, the catalyst distribution at the core of the substrate 14 may be further defined in terms of smaller cores. For example, the upstream converter 10 may comprise greater than or equal to 30 wt % catalyst disposed at a core having a diameter less than or equal to 30% of the overall diameter of the substrate, wherein the weight percent is based on the total weight of the catalyst used in the substrate. Moreover, greater than or equal to 50 wt % catalyst may disposed at a core having a diameter less than or equal to 44% of the overall diameter of the substrate. Greater than 70 wt % catalyst may be disposed at a core having a diameter less than or equal to 63% of the overall diameter of the substrate.

Upstream converter 10 employs endplate 22 or similar device that forces the exhaust fluid flow through the center/core of substrate 14, where the catalyst is substantially located. In contrast, an end-cone would distribute fluid flow over the entire substrate, which results in slower light-off times compared to a converter employing the endplate.

In addition to having the flow volume through the substrate established to attain the desired light-off characteristics, the upstream converter (i.e., the converter fluidly disposed between the engine and the downstream converter) is preferably also designed to have a laminar flow from the engine through the substrate. Therefore, an angle θ of about 90° (e.g., about 80° to about 100°) between the endplate face and the conduit 20 to the engine is preferred (see FIG. 1). As a result, an endplate is preferably disposed at the inlet end with the substrate comprising a catalyst concentration gradient such that the concentration of catalyst in the laminar flow area is greater than or equal to 60 wt % of the total weight of the catalyst, the substrate is located sufficiently close to the end plate to maintain laminar flow therethrough (e.g., located at a distance “d” of less than or equal to 10 mm), and the angle between the endplate and the conduit is preferably 90°+/−5°.

In one embodiments, the exhaust conduit 20 can extend past the endplate 22 by about 3 millimeters (mm) to about 10 mm, with about 3 mm to about 7 mm preferred. Further, the end of inlet exhaust conduit 20 is preferably disposed less than or equal to 15 mm away from the upstream catalyst substrate, with less than or equal to 10 mm away from the upstream catalyst substrate preferred, and less than or equal to 5 mm away from the upstream catalyst substrate more preferred.

In making upstream converter 10, any process capable of producing the desired concentration gradient can be employed. For example, the catalyst can be disposed on the substrate by dipping, spraying, or otherwise applying a catalyst mixture. The substrate 14 is then preferably dried from the inside out to create a concentration gradient within the substrate. This process can create a gradient where greater than about 60 wt % of the total catalyst is disposed in the core of the substrate. Accordingly, in an exemplary method of drying substrate 14, a microwave drier is used. Microwaves heat from the inside of an object out toward the surface of the object. Therefore, if a microwave drier were used, catalyst would be drawn toward the center, i.e., the core of round substrate 14. For example, water can carry the catalyst (e.g., precious metals) towards the drying center. As the microwaved center is heated, super heated steam is released out the end of the center channels. The steam migration allows for a substantially even distribution of precious metals along the length of the channels.

Alternatively, this same effect may be achieved by forcing dry air through the middle of the substrate. Microwave drying is more advantageous in that it may achieve the same results in less space, i.e., the drying chamber size is reduced when a microwave drier is employed, with less equipment and in less time compared to air dryers.

In contrast to upstream converter 10, downstream converter 12 is designed primarily for steady state operations. Downstream converter 12 is preferably an under-floor converter. As such, downstream converter 12 generally has a lower operating temperature compared to upstream converter 10. Downstream converter 12 has an operating temperature up to about 600° C.; within this range temperatures are generally less than or equal to 400° C. Generally, the heat difference between upstream converter and downstream converter may be attributed to exhaust conduit 30. The farther downstream converter 12 is located away from upstream converter 10, the larger the heat dissipation from conduit 30 will be. At the higher operating temperatures of upstream converter 10, conversion of nitrogen oxides (NOₓ) may be lower than 70 wt % based upon the total wt of NOₓ entering the upstream converter. However, the temperatures of downstream converter are more favorable for nitrogen oxide reduction. As such, NOₓ remaining in the exhaust fluid after passing through upstream catalytic converter 10 may be reduced in downstream converter 12.

In an exemplary embodiment, the downstream converter is designed to create a turbulent flow such that the exhaust fluid is distributed throughout the converter and not merely through the core. Consequently, an end cone is preferably employed at the downstream converter inlet and/or the substrate 32 is located a sufficient distance from the end cone to induce a turbulent fluid flow. In this figure, downstream converter 12 comprises endcone 38, which cause turbulent flow over substrate 32 allowing for exhaust fluid to be dispersed over the entire substrate. Although downstream converter 12 may have any size or shape, downstream converter 12 preferably has a size and shape substantially the same as substrate 32, which may have any shape, for example, oval or round. Preferably, substrate 32 has an oval or otherwise elongated shape in the direction perpendicular to the flow to further induce turbulence. Substrate 32 has catalyst substantially dispersed throughout, i.e., greater than or equal to 60 wt % of the catalyst is preferably dispersed at the bulk of substrate, with greater than or equal to 80 wt % preferred. As such, substrate 32 allows for better steady state performance compared to substrate 14. Substrate 32 may obtain this catalyst dispersion by disposing the catalyst on the substrate and drying, e.g., in an oven.

In various embodiments, the downstream converter 12, is designed to attain a turbulent flow upstream of the catalytic substrate 32. For example, the exhaust conduit 30 can extend past endcone 38 a distance to allow turbulent flow in the downstream converter 12. For example, the exhaust conduit 30 extends beyond the endcone 38 a distance less than or equal to 10 mm, with less than or equal to 5 mm preferred, and about 0 mm more preferred.

Since the flow and catalytic reactions take place throughout substrate 32, heat is dispersed over the entire substrate, which prevents overheating of catalyst substrate 32. Unlike upstream converter 10, were higher temperatures are advantageous for a fast light-off time, higher temperatures in downstream converter 12 relate to a decrease in NOx conversion. As such, the heat dispersion is advantageous for increased NOx conversion.

Referring now to FIG. 2, a catalytic converter system generally designated 200 is illustrated. In this embodiment, no-closed coupled converter is employed. Rather, the various design features that are disclosed herein are incorporated into a single package, which is an under-floor converter. Converter system 200 comprises an upstream substrate 202 and a downstream substrate 204 having a gap 206 disposed between the upstream substrate and the downstream substrate. A retention material 208 is disposed between the housing 210 and the downstream substrate 204, and gap 206. An endplate 212 having an opening 214 is coupled to housing 210 at an inlet side. An end-cone 218 is coupled to housing 210 at an outlet side.

An arrow labeled “flow direction” schematically illustrates the general flow direction of exhaust in system 200. Exhaust fluid enters system 200 through opening 214 of endplate 212 from exhaust conduit 216, which is coupled to endplate 212 at an angle 0 of about 90-degree from the face of endplate 212, allowing laminar flow in upstream substrate 202. Gap 206 between upstream substrate 202 and downstream substrate 204 is sufficient to create turbulent flow in the exhaust fluid prior to entering substrate 204. While gap 206 may be any size sufficient to cause turbulent flow, a gap 206 of less than or equal to 30 millimeters (mm) is preferred, with about 10 mm to about 20 mm more preferred. The exhaust fluid then enters substrate 204, and eventually exists system 200 through end-cone 218 having opening 220 in fluid communication with exhaust conduit 222 as with converters 10 and 12, the end piece of this converter 200 can be an end plate or end cone. However, end cones are preferred at the outlet to facilitate flow out of the converters and avoid dead flow areas. Compared to the system embodied in FIG. 1, the system embodied in FIG. 2 has the advantage of being packaged in a single housing. As such, a cost savings may be recognized. More particularly, one end plate, and one end cone are employed instead of four end pieces. Additionally, less retention material may be used, and less process time may be realized as result of a reduction in welding time. However, these advantages may be outweighed in some instances where a slower resulting light-off time is achieved, compared to the light-off time of a separate close-couple converter disclosed herein.

In an exemplary embodiment, substrates 202 can be similar in shape and design to catalyst substrate 14 described above, while substrate 204 is similar in design to substrate 32, it preferably is rounded for simplified packaging manufacture in a single housing 210.

Catalyst substrates 14, 32, 202, and 204 may comprises any material designed for use in a spark ignition or diesel engine environment and having the following characteristics: (1) capable of operating at temperatures up to about 800° C., (2) capable of withstanding exposure to hydrocarbons, nitrogen oxides, carbon monoxide, particulate matter (e.g., soot and the like), carbon dioxide, and/or sulfur; and (3) having sufficient surface area and structural integrity to support a catalyst. Some possible materials include cordierite, silicon carbide, metal, metal oxides (e.g., alumina, and the like), glasses, and the like, and mixtures comprising at least one of the foregoing materials. Some ceramic materials include “Honey Ceram”, commercially available from NGK-Locke, Inc, Southfield, Michigan, and “Celcor”, commercially available from Corning, Inc., Corning, N.Y. These materials may be in the form of foils, perform, mat, fibrous material, monoliths (e.g., a honeycomb structure, and the like), other porous structures (e.g., porous glasses, sponges), foams, pellets, particles, molecular sieves, and the like (depending upon the particular device), and combinations comprising at least one of the foregoing materials and forms, e.g., metallic foils, open pore alumina sponges, and porous ultra-low expansion glasses. Furthermore, these substrates may be coated with oxides and/or hexaaluminates, such as stainless steel foil coated with a hexaaluminate scale. Preferably, substrate (e.g., 14, 32, 202, and 204) comprises a ceramic material.

Disposed substantially in the core of and/or throughout the substrate (e.g., 14, 32, 202, and 204) is a catalyst capable of reducing the concentration of at least one component in the gas. The catalyst may be wash coated, imbibed, impregnated, physisorbed, chemisorbed, precipitated, or otherwise applied to the substrate. Possible catalyst materials include metals, such as platinum, palladium, rhodium, iridium, osmium, ruthenium, tantalum, zirconium, yttrium, cerium, nickel, manganese, copper, and the like, as well as oxides, alloys, and combinations comprising at least one of the foregoing catalysts, and other catalysts. It is noted that, since the upstream catalyst mostly reduces hydrocarbon concentration while the downstream catalyst is directed to reducing NOₓ concentration, the upstream and downstream catalyst may have different compositions accordingly.

Disposed between substrate (e.g., 14, 32, 202, 204) and housing (e.g. 18, 36, 210) is a retention material (e.g., 18, 34, 208) that insulates the housing from both the high exhaust fluid temperatures and the exothermic catalytic reaction occurring within the catalyst substrate. The retention material, which enhances the structural integrity of the substrate by applying compressive radial forces about it, reducing its axial movement and retaining it in place, may be disposed around the substrate to form a retention material/substrate subassembly.

The retention material may be in the form of a mat, particulates, or the like, and may be an intumescent material (e.g., a material that comprises vermiculite component, i.e., a component that expands upon the application of heat), a non-intumescent material, or a combination thereof. These materials may comprise ceramic materials (e.g., ceramic fibers) and other materials such as organic and inorganic binders and the like, or combinations comprising at least one of the foregoing materials. Non-intumescent materials include materials such as those sold under the trademarks “NEXTEL” and “INTERAM 1101HT” by the “3M” Company, Minneapolis, Minn., or those sold under the trademark, “FIBERFRAX” and “CC-MAX” by the Unifrax Co., Niagara Falls, N.Y., and the like. Intumescent materials include materials sold under the trademark “INTERAM” by the “3M” Company, Minneapolis, Minn., as well as those intumescents which are also sold under the aforementioned “FIBERFRAX” trademark, as well as combinations thereof and others.

The retention material/substrate subassembly may be concentrically disposed within a housing (e.g., 18, 36, 210) such that the retention material is located between the substrate and the housing. The choice of material for the housing depends upon the type of exhaust gas, the maximum temperature reached by the substrate, the maximum temperature of the exhaust gas stream, and the like. Suitable materials for the housing may comprise any material that is capable of resisting under-car salt, temperature, and corrosion. For example, ferrous materials can be employed such as ferritic stainless steels, as well as various metal alloys, such as alloys of nickel, chromium and/or iron. Ferritic stainless steels may include stainless steels such as, e.g., the 400-Series such as SS-409, SS-439, and SS-441, with grade SS-409 generally preferred.

Additionally, end-cones (e.g., 38, 42, 218), endplates (e.g., 22, 212), and the like may comprise material similar to those used for the housing. These components may be formed separately (e.g., molded or the like), or may be formed integrally with the housing using methods such as, e.g., a spin forming, or the like.

Exhaust conduit (e.g., 20, 30, 46, 216, 222) preferably has a size and shape to accommodate exhaust fluid flow. Preferably, the exhaust conduit has a diameter of about 1.5 inches (about 3.81 cm) to about 3.5 inches (about 8.89 cm). The exhaust conduit may comprise similar materials to those used for the housing. In various embodiments, the exhaust conduit may be double walled to minimize heat transfer from the exhaust conduit.

The catalytic converters may be manufactured by one or more techniques, and, likewise, the retention material/substrate subassembly may be disposed within the housing using one or more methods. For example, the retention material/substrate subassembly may be inserted into a variety of housings using a stuffing cone. The stuffing cone is a device that compresses the retention material (in the form of a mat) concentrically about the substrate. The stuffing cone then stuffs the compressed retention material/substrate subassembly into the housing, such that an annular gap preferably forms between the substrate and the interior surface of the housing as the retention material becomes compressed about the substrate. Alternatively, if the retention material is in the form of particles (e.g., pellets, spheres, irregular objects, or the like) the substrate may be stuffed into the housing and the retention material may be disposed in the housing between the substrate and the housing.

In an alternative method, for example, the housing/shell may comprise two half shell components, also known as clamshells. The two half shell components are compressed together about the retention material/substrate subassembly, such that an annular gap preferably forms between the substrate and the interior surface of each half shell as the retention material becomes compressed about the substrate.

In yet another method for forming the exhaust emission control device, the shell may have a non-circular cross-sectional geometry (e.g., oval, oblong, and the like). This method is particularly useful for downstream converter 12, which comprises an oval substrate. Such non-circular housing designs are preferably manufactured by employing a half shell, preferably a die formed clamshell, which, when combined with another half, may form the desired non-circular geometry. The retention material/substrate subassembly may be placed within one of the half shells. The other half shell may then be attached to that half shell, such that an annular gap preferably forms between the substrate and the interior surface of each half shell (i.e., the area comprising the retention material). The half shells may be welded together, preferably using a roller seam welding operation.

The “tourniquet” method of forming the catalytic converter comprises wrapping the shell (e.g., in the form of a sheet) around the retention material/substrate subassembly. The adjoining edges of the shell are welded together while the assembly is squeezed at rated pressures calculated to optimize the retention material density. The end-cones/end-plates or the like, are then welded to the shell to form the converter. Although this method also has the disadvantages of increased cost due to the number of components that have to be processed and the added cost of welding wires and gases, it claims improved retention material density control.

In any of the above methods, the ends of the housing may be sized, e.g., using a spinform method, to form a conical shaped inlet and/or a conical shaped outlet, thus eliminating the need for separate end cone assemblies in at least one embodiment. For example, this method may be particularly useful for converter 12. In the alternative, one or both ends of the shell may also be sized so that an endcone and an end plate may be attached to provide a gas tight seal. This method is particularly useful, for example, in catalytic converter 200, which comprises both end plate 212 and end-cone 218.

In other embodiments, a catalytic converter(s) comprises more than two substrates. Advantageously, these embodiments may be configured to allow for fast light-off times, i.e., less than or equal to 25 seconds, with less than or equal to about 15 seconds achievable, throughout the life of the converter. The following non-limiting examples illustrate these embodiments. First, however, performance data for various configurations of converters is disclosed.

### EXAMPLES

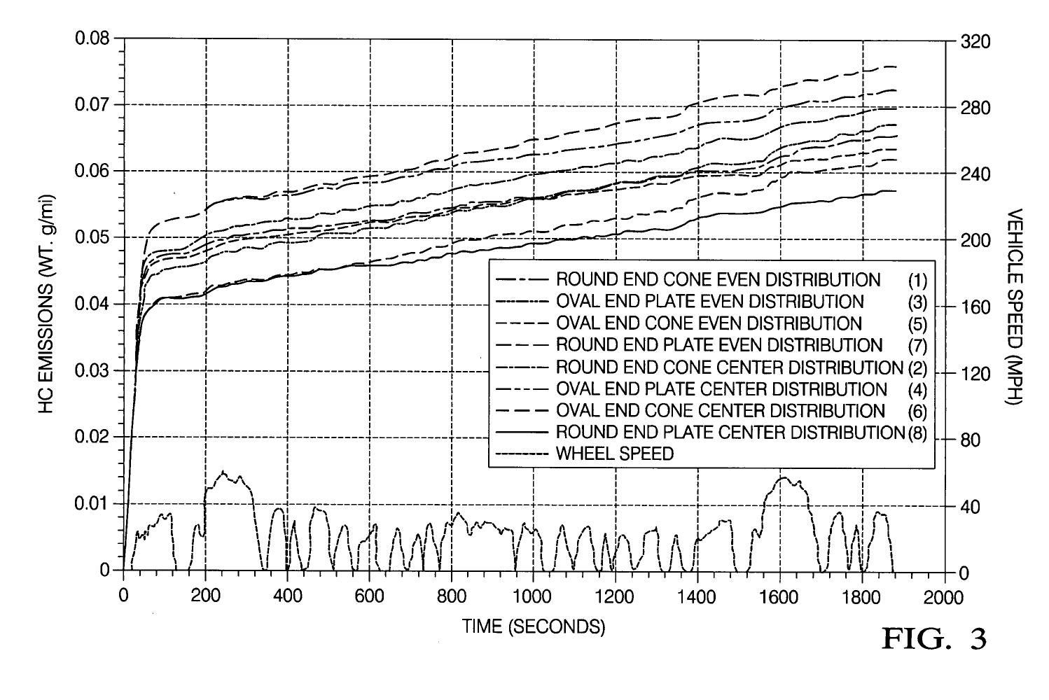

Hydrocarbon emissions were studied as a function of substrate shape, endplate and end cone configurations, and catalyst distribution. These results are summarized in FIG. 3, which is graph of hydrocarbon emissions release weight in grams (wt. g/mi) per mile as a function of time. The following eight configurations were studied: (1) a converter comprising a round shape substrate with catalyst substantially (e.g., greater than or equal to 60 wt %) distributed at the bulk of the substrate and employing end cones; (2) a converter comprising a round shaped substrate with catalyst substantially distributed at the core and employing endcones; (3) a converter comprising an oval shaped substrate with catalyst substantially distributed at the bulk of the substrate and employing end plates; (4) a converter comprising an oval shaped substrate with catalyst substantially distributed at the core and employing end plates; (5) a converter comprising an oval shaped substrate catalyst substantially distributed at the bulk of the substrate and employing endcones; (6) a converter comprising an oval shaped substrate with catalyst substantially distributed at the core and employing endcones; (7) a converter comprising a round shaped substrate with catalyst substantially distributed at the bulk of the substrate and employing end plates; (8) a converter comprising a round shaped substrate with catalyst substantially distributed at the core and employing end plates.

FIG. 3 illustrates the fact that greater than or equal to fifty percent of all the hydrocarbons released in the approximately 1,900 second test occurred within about 60 seconds to about 100 seconds. A converter that has a fast light-off time will therefore have reduced overall hydrocarbon emissions. Test Sample 8 had the lowest overall hydrocarbon emissions. In contrast test sample 6, had the highest overall hydrocarbon emissions.

### Examples of Substrate Configurations

A closed-couple converter (e.g. 10) may comprise an upstream substrate and a downstream substrate. The combined length of the upstream substrate and the downstream substrate is preferably less than or equal to 6 inches (about 15.24 cm). However, the substrates may be arranged in any combination. For example, the upstream substrate and the downstream substrate may both be 3 inches (about 7.62 cm) or the upstream substrate may be two inches (about 5.08 cm) and the downstream substrate may be 4 inches (about 10.16 cm). In this example, the upstream substrate has a catalytic metal (e.g., platinum group metals) concentration of greater than or equal to 2 times the catalytic metal per cubic inch as the downstream substrate, i.e., at least two-thirds of the platinum group metals employed in the converter are preferably disposed on the upstream substrate. Preferably, a gap of less than or equal to 2 millimeters (mm) is disposed between the two substrates, wherein the gap is greater than 0 mm. If the gap is 0 mm, i.e., there is no gap, the brick faces can rub together, fracture and plug the inlet of the downstream substrate.

Generally, in a new converter, a light-off exotherm occurs in the first 2 inches (about 5.08 cm) of the upstream substrate. As the upstream substrate accumulates poisons, the light-off exotherm point moves toward the outlet. For example, a converter at about 125,000 miles (about 160,934 kilometers) generally has a light-off exotherm occurring at a distance of greater than or equal to 2 inches (about 5.08 cm) from the inlet face of the upstream substrate.

### Example 1

A single substrate comprises a catalytic metal loading of about 40 g/ft³ (about 1,412 grams per cubic meter (g/m³)) distributed evenly along the 6 inch (about 15.24 cm) length of a substrate prior to drying. The term “evenly” as used herein refers to greater than or equal to 60 wt % catalytic metal distributed over the substrate. In this example, the effect of microwave drying causes about 60 wt % of the catalytic metal to migrate from the substrate skin towards the central axis. A 5 inch (12.7 cm) diameter substrate with about 40 g/ft³ (about 1,412 g/m³) catalytic metal distributed evenly along the 6 inch (15.24 cm) length of a substrate, would upon drying yield about 60 wt % of the catalytic metal at a center core about 2.5 inches (about 6.35 cm) wide and 6 inches (about 15.24 cm) long. About 40 wt % of the catalytic metal would remain in the outer region starting at 1.25 inches (about 3.12 cm) from the center, ending at 2.5 inches (about 6.35 cm) from the center and 6 inches (about 15.24 cm) long. Thus, the final dried and calcined substrate would contain at the center core 2.5 inches (6.35 cm) wide and 6.0 inches (15.24 cm) long a catalytic metal loading of about 110 g/ft³ (about 3885 g/m³) and would contain in the region outside that center core a ring 1.25 inches (about 3.12 cm) wide and 6 inches (15.24 cm) long a catalytic metal loading of about 12 g/ft³ (about 424 g/m³). The centermost core cells along the gas flow axis could have a catalytic metal loading up to about 180 g/ft³ (about 6357 g/m³) and the concentration would decrease towards the substrate skin with the last substrate cells before the skin having a catalytic metal loading of about 6 g/ft³ (about 212 g/m³).

### Example 2

In this example, a upstream substrate is 2 inches (5.08 cm) long and has catalytic metal loading of 80 g/ft³ (about 2,826 g/m³) distributed evenly through the substrate prior to drying, and a downstream substrate is 4 inches (10.16 cm) long loaded and has a catalytic metal loading of about 20 g/ft³ (about 706 g/m³) prior to drying. The effect of microwave drying can cause about 60 wt % of the catalytic metal to migrate from the substrate skin towards the central axis. A 5 inch (12.7 cm) diameter substrate with a loading of about 80 g/ft³ (about 2,826 g/m³) distributed evenly along the first 2 inches (5.08 cm) along the gas flow axis, would upon drying yield about 60 wt % of the catalytic metal at a center core about 2.5 inches (6.35 cm) wide and 2 inches (about 5.08 cm) along the gas flow axis, and 40 wt % of the catalytic metal in the outer region starting at 1.25 inches (about 3.12 cm) from the center, ending at 2.5 inches (about 6.35 cm) from the center and 2 inches (about 10.16 cm) along the gas flow axis. Thus, the final dried and calcined substrate would contain at the center core 2.5 inches (about 6.35 cm) wide and 2.0 inches (about 5.08 cm) long a catalytic metal loading of about 192 g/ft³ (about 6,781 g/m³), and would contain in the region outside that center core a ring 1.25 inches (about 3.12 cm) wide and 2 inches (about 10.16 cm) long with a loading of about 41 g/ft³ (about 493 g/m³).

A 5 inch (about 12.7 cm) diameter substrate with a catalytic metal loading of about 20 g/ft³ (about 706 g/m³) distributed evenly along the 4 inch (about 10.16 cm) length of a substrate, would upon drying yield about 60 wt % of the catalytic metal at a center core about 2.5 inches (about 6.35 cm) wide and 4 inches (about 10.16 cm) long, and 40 wt % of the catalytic metal in the outer region starting at 1.25 inches (about 3.12 cm) from the center, ending at 2.5 inches (about 6.35 cm) from the center and about 4 inches (about 10.16 cm) long. Thus, the final dried and calcined substrate would contain at the center core 2.5 inches (about 6.35 cm) wide and 4.0 inches (about 10.16 cm) long a catalytic metal loading of about 49 g/ft³ (about 1730 g/m³), and would contain in the region outside that center core a ring 1.25 inches (about 3.12 cm) wide and 2 inches (about 5.08 cm) long with a loading of about 11 g/ft³.

### Example 3

An upstream substrate is 3 inches (about 7.62 cm) long and has a catalytic metal loading of about 60 g/ft³ (about 2,118 g/m³) prior to drying, and the downstream substrate is 3 inches (about 7.62 cm) long with a catalytic metal loading of about 20 g/ft³ (about 706 g/m³) prior to drying. The effect of microwave drying causes about 60 wt % of the catalytic metal to migrate from the substrate skin towards the central axis. The upstream substrate, upon drying, would yield about 60 wt % of the catalytic metal at a center core about 2.5 inches (about 6.35 cm) wide and 3 inches (about 7.62 cm) along the gas flow axis, and 40 wt % of the catalytic metal in the outer region starting at 1.25 inches (about 3.12 cm) from the center, ending at 2.5 inches (about 6.35 cm) from the center and about 3 inches (7.62 cm) along the gas flow axis. Thus, the final dried and calcined substrate would contain at the center core 2.5 inches (about 6.35 cm) wide and 3.0 inches (7.62 cm) long a loading of about 144 g/ft³ (about 5,085 g/m³), and would contain in the region outside that center core a ring 1.25 inches (about 3.12 cm) wide and 3 inches (about 7.62 cm) long with a loading of about 32 g/ft3 (about 1,130 g/m³). The downstream substrate would upon drying yield about 60 wt % of the catalytic metal at a center core about 2.5 inches (about 6.35 cm) wide and 3 inches (about 7.62 cm) long, and about 40 wt % of the catalytic metal in the outer region starting at 1.25 inches (about 3.12 cm) from the center, ending at 2.5 inches (about 6.35 cm) from the center and about 3 inches (about 7.62 cm) long. Thus, the final dried and calcined downstream substrate would contain at the center core 2.5 inches (about 6.35 cm) wide and 3 inches (about 7.62 cm) long a loading of about 49 g/ft³ (about 493 g/m³), and would contain in the region outside that center core a ring 1.25 inches (about 3.12 cm) wide and 3 inches (about 7.62 cm) long a loading of about 11 g/ft³ (about 389 g/m³).

Consider a catalyst system with 125,000 miles (about 201,168 kilometers) in service use, heavily poisoned with exhaust gas contaminates such as phosphorus and zinc. The light-off region of such a catalyst system would generally occur at the center core in the region around the third inch along the gas flow axis. The third inch along Example 3 would contain a loading of about 144 g/ft³ (about 5,085 g/m³); the third inch along Example 2 would contain a loading of about 49 g/ft³ (about 1,730 g/m³); and the third inch along Example 1 would contain a loading of about 10 g/ft³ (about 353 g/m³).

Microwave drying allows concentration gradients higher at the central core along the gas flow axis. High catalytic metal concentrations at the center core along the gas flow axis give Examples 1, 2 and 3 all fast light-off, i.e., less than or equal to 25 seconds, with less than or equal to 15 seconds achievable. However, considering a 125,000 mile (about 201,168 kilometers) durability requirement, microwaved dried Example 3 having a loading of about 144 g/ft³ (about 5,085 g/m³) in the center concentration is preferred.

Advantageously, embodiments disclosed herein allow for fast light-off times, i.e., less than or equal to 25 seconds, with less than or equal to 15 seconds achievable. In addition to providing fast light-off times, the catalytic converter systems disclosed are effective in steady state operation for the reduction of nitrogen oxides and carbon monoxide. These systems preferably combine the type of end piece with the substrate geometry and/or catalyst distribution to enhance emission reduction.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A catalytic converter system comprising:
an upstream substrate having an upstream catalyst disposed thereon, wherein greater than or equal to 70 wt % of the upstream catalyst is disposed at a core of the upstream substrate, wherein the weight percent is based on a total weight of the upstream catalyst disposed on the upstream substrate.

2. The catalytic converter system of claim 1, wherein the upstream substrate is configured to receive greater than or equal to 60% of an exhaust flow volume through the core.

3. The catalytic converter system of claim 2, wherein the upstream substrate is configured to receive greater than or equal to 70% of the exhaust flow volume through the core.

4. The catalytic converter system of claim 1, wherein a closed-couple converter comprises the upstream substrate.

5. The catalytic converter system of claim 1, wherein the upstream substrate is a rounded substrate.

6. The catalytic converter system of claim 1, wherein greater than or equal to 50 wt % of the upstream catalyst is disposed at a reduced core having a diameter less than or equal to 44% of an overall diameter of the upstream substrate.

7. The catalytic converter system of claim 6, wherein greater than or equal to 30 wt % of the upstream catalyst is disposed at a second reduced core having a diameter less than or equal to 30% of the overall diameter of the upstream substrate.

8. The catalytic converter system of claim 1, wherein an upstream converter comprises the upstream substrate, an inlet end, and an outlet end, wherein the inlet end comprises an endplate.

9. The catalytic converter system of claim 8, wherein an exhaust conduit is coupled to the end plate at an angle θ of about 90 degrees to a face of the end plate.

10. The catalytic converter system of claim 1, wherein in the system is capable of obtaining a light-off in less than or equal to 25 seconds.

11. The catalytic converter system of claim 1, further comprising a downstream substrate in fluid communication with an upstream substrate, wherein the downstream substrate comprises a downstream catalyst disposed thereon, wherein greater than or equal to 60 wt % downstream catalyst is distributed at a bulk of the downstream substrate.

12. The catalytic converter system of claim 11, wherein greater than or equal to 80 wt % of the downstream catalyst is distributed at the bulk of the downstream substrate.

13. The catalytic converter system of claim 11, further comprising an under-floor converter comprises the downstream substrate.

14. The catalytic converter system of claim 11, wherein the under floor converter comprises an inlet portion configured to cause turbulent flow in the downstream substrate.

15. The catalytic converter system of claim 14, wherein the inlet portion comprises an endcone.

16. The catalytic converter system of claim 11, wherein the upstream substrate and the downstream substrate are disposed in a housing, wherein a gap is disposed between the upstream substrate and the downstream substrate sufficient to create turbulent flow in the exhaust fluid prior to entering the downstream substrate.

17. The catalytic converter system of claim 16, wherein the gap is up to about 20 mm in length.

18. The catalytic converter of claim 17, wherein the gap is about 10 mm to about 20 mm in length.

19. A method of making a catalytic converter, the method comprising:
disposing an upstream catalyst on an upstream substrate; and
drying the upstream substrate, wherein greater than or equal to 60 wt % based on a total weight of catalyst disposed in the upstream substrate is disposed at a core of the upstream substrate.

20. The method of claim 19, wherein the upstream substrate is dried with a microwave drier.

21. The method of claim 19, further comprising disposing a downstream catalyst on a downstream substrate; and drying the downstream substrate, wherein greater than or equal to 60 wt % based on a total weight of the catalyst disposed in the downstream substrate is distributed at a bulk of the downstream substrate.

22. The method of claim 21, wherein the downstream substrate is dried in an oven.

23. The method of claim 21, further comprising disposing a retention material around the upstream substrate and the downstream substrate such that the retention material is between a housing and the upstream substrate and the downstream substrate, and wherein a gap of up to about 20 mm is created between the upstream substrate and the downstream substrate.

24. A catalytic converter system comprising:
an upstream substrate capable of maintaining laminar fluid flow therethrough; and
a downstream substrate in fluid communication with the upstream substrate, wherein the downstream substrate is capable of maintaining turbulent flow at least through a portion thereof.

25. The system of claim 24, wherein the upstream substrate comprises a rounded shape and an upstream catalyst disposed thereon, wherein greater than or equal to 60 wt % based on a total weight of the upstream catalyst is disposed at a core of the upstream substrate; and wherein the downstream catalytic downstream substrate comprises a downstream catalyst disposed thereon, wherein greater than or equal to 60 wt % based on a total weight of the catalyst material disposed on the downstream substrate is distributed throughout a bulk of the substrate downstream substrate.
